(19) United States
(12) Patent Application Publication
(10) Pub. No.: US 2025/0180861 A1
(43) Pub. Date: Jun. 5, 2025

(54) REFLECTIVE MODULE AND CAMERA MODULE INCLUDING THE SAME

(71) Applicant: SAMSUNG ELECTRO-MECHANICS CO., LTD., Suwon-si (KR)

(72) Inventors: Young Hwan KWON, Suwon-si (KR); Do Seop HWANG, Suwon-si (KR); Young Bok YOON, Suwon-si (KR); Byung Woo KANG, Suwon-si (KR)

(73) Assignee: SAMSUNG ELECTRO-MECHANICS CO., LTD., Suwon-si (KR)

(21) Appl. No.: 18/938,621

(22) Filed: Nov. 6, 2024

(30) Foreign Application Priority Data
Nov. 30, 2023 (KR) 10-2023-0171679
Apr. 29, 2024 (KR) 10-2024-0057099

(51) Int. Cl. G02B 7/182

(52) U.S. Cl. CPC G02B 7/1828

(57) ABSTRACT

A reflective module includes a holder on which a reflective member is disposed to reflect light passing through a first lens module; a guide member on which the holder is disposed; a housing accommodating the holder and the guide member; a first ball member, disposed between the guide member and the housing, including a plurality of balls spaced apart in a first rotation axis, perpendicular to the first optical axis; and a second ball member, disposed between the holder and the guide member, including a plurality of balls spaced apart in a direction of a second rotation axis perpendicular to both the first optical axis and the first rotation axis. The guide member is configured to rotate about the first rotation axis, together with the first lens module and the holder. The first lens module and the holder are configured to rotate together about the second rotation axis.

### CROSS-REFERENCE TO RELATED APPLICATIONS

This application claims the benefit under 35 USC 119(a) of Korean Patent Application No. 10-2023-0171679, filed on Nov. 30, 2023, and Korean Patent Application No. 10-2024-0057099, filed on Apr. 29, 2024, in the Korean Intellectual Property Office, the entire disclosures of which are incorporated herein by reference for all purposes.

### BACKGROUND

### 1. Field

The present disclosure relates to a reflective module and a camera module comprising the same.

### 2. Description of the Background

Camera modules, e.g., used in mobile devices, may bend the path of light by disposing a reflective member in front of a lens module. This type of camera module may have limitations in increasing the diameter of the lens because the diameter of the lens provided in the lens module affects the thickness of the mobile device. Therefore, there may be a problem in that it may be difficult to reduce the F-number of the camera module.

Accordingly, a structure in which some lenses are disposed in front of the reflective member has been proposed.

Meanwhile, the camera module has a shake correction function that corrects shake during shooting to increase resolution. This shake compensation function may be implemented through a two-axis rotation of the reflective member. In this case, the two-axis rotation may be implemented through pitch rotation and yaw-wise rotation. Here, when a lens is disposed in front of the reflective member, the lens may be rotated together with the reflective member.

Here, the pitch rotation axis and the yaw-wise rotation axis mean two axes perpendicular to the optical axes of the lenses disposed behind the reflective member and are perpendicular to each other.

For example, rotation based on the Yaw axis may be implemented by rotating the reflective member using a direction in which light is incident on the reflective member as the rotation axis, and rotation based on the Pitch axis may be implemented by rotating the Yaw axis and the lenses disposed behind the reflective member. Rotation may be implemented by rotating the reflecting member using an axis perpendicular to the optical axis as the rotation axis.

Here, when the reflective member rotates yaw-wise, an error may occur in the change in an intended optical path length.

The reason is that in the case of yaw-wise rotation, among two-axis rotation, the apparent positional change of the lens disposed in front of the reflective member before and after yaw-wise rotation may not be significant.

Therefore, when correcting shaking in the yaw direction, there may be a problem that a large aberration may occur, and the resolution may deteriorate.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a reflective module includes a first lens module having a first optical axis; a holder on which a reflective member is disposed to reflect light passing through the first lens module; a guide member on which the holder is disposed; a housing accommodating the holder and the guide member; a first ball member, disposed between the guide member and the housing, including a plurality of balls spaced apart in a direction of a first rotation axis, perpendicular to the first optical axis; and a second ball member, disposed between the holder and the guide member, including a plurality of balls spaced apart in a direction of a second rotation axis perpendicular to both the first optical axis and the first rotation axis. The guide member is configured to rotate about the first rotation axis, together with the first lens module and the holder. The first lens module and the holder are configured to rotate together about the second rotation axis. The reflective member is disposed between the plurality of balls of the first ball member.

A first guide groove may be disposed on the guide member, a second guide groove may be disposed on the housing, and the first guide groove and the second guide groove may face each other in the direction of the first optical axis. The first ball member may be disposed between the first guide groove and the second guide groove. Some balls of the plurality of balls of the first ball member may have a different total number of contact points with the first guide groove and the second guide groove than other balls of the plurality of balls of the first ball member.

A third guide groove may be disposed in the holder, a fourth guide groove may be disposed in the guide member, and the third guide groove and the fourth guide groove may face each other in the direction of the first optical axis. The second ball member may be disposed between the third guide groove and the fourth guide groove. Some balls of the plurality of balls of the second ball member may have a different total number of contact points with the third guide groove and the fourth guide groove than other balls of the plurality of balls of the second ball member.

The reflective module may further include a first driving unit including a first magnet disposed on the guide member and a first coil disposed to face the first magnet in the direction of the first optical axis. One surface of the first magnet facing the first coil may have an N-pole, a neutral region, and an S-pole in the direction of the second rotation axis.

A virtual line connecting the plurality of balls of the first ball member may be offset from the first magnet in the direction of the first optical axis.

A first pulling yoke spaced apart from the first magnet in the direction of the first optical axis may be disposed in the housing.

A first pulling magnet may be disposed on one of the holder or the guide member, and a second pulling yoke may be disposed on another thereof. The first pulling magnet and the second pulling yoke may face each other in the direction of the first optical axis. One surface of the first pulling magnet facing the second pulling yoke may have an N-pole, a neutral region, and an S-pole in the direction of the second rotation axis.

A length of the pulling yoke in the direction of the first rotation axis may be longer than a length of the first pulling magnet in the direction of the first rotation axis.

The first pulling magnet and the second pulling yoke may be disposed between the plurality of balls of the second ball member.

The reflective module may further include a second driving unit including a second magnet disposed in the holder and a second coil disposed to face the second magnet in the direction of the first rotation axis. One surface of the second magnet facing the second coil may have an N-pole, a neutral region, and an-S pole along the first optical axis.

A virtual line connecting the plurality of balls of the second ball member may be offset from the second magnet in the direction of the first rotation axis.

A first stopper, coupled to the housing, may cover at least a portion of the upper surface of the holder. A buffer member may be disposed on at least one surface of the first stopper and the holder facing the direction of the first optical axis.

A second stopper may be coupled to the guide member. The holder may have a receiving portion in which a portion of the second stopper is disposed. The portion of the second stopper may have a surface facing the receiving portion in the direction of the first optical axis.

In another general aspect, a camera module include a guide member disposed in a housing to rotate about a first rotation axis; a holder disposed on the guide member to rotate relative to the guide member based on a second rotation axis perpendicular to the first rotation axis, and on which a reflective member is disposed; a first ball member disposed between the guide member and the housing; a second ball member disposed between the holder and the guide member; a first lens module disposed on the holder and having a first optical axis perpendicular to both the first and second rotation axes; and a second lens module into which light reflected from the reflective member is incident, and having a second optical axis. The first rotation axis is perpendicular to both the first optical axis and the second optical axis.

The camera module may further include an image sensor configured to receive light passing through the second lens module. The image sensor may have an imaging plane that is inclined with respect to the second optical axis.

The camera module may further include a first driving unit including a first magnet disposed on the guide member, and a first coil disposed to face the first magnet in a direction of the first optical axis; and a second driving unit including a second magnet disposed in the holder and a second coil disposed to face the second magnet in a direction of the first rotation axis. The first ball member may include a plurality of balls spaced apart in the direction of the first rotation axis. The second ball member may include a plurality of balls spaced apart in a direction of the second rotation axis.

A first pulling yoke spaced apart from the first magnet in the direction of the first optical axis may be disposed in the housing. A first pulling magnet may be disposed on one of the holder or the guide member, and a second pulling yoke facing the first pulling magnet in the direction of the first optical axis may be disposed on another thereof. The first pulling magnet and the second pulling yoke may be disposed between the plurality of balls of the second ball member.

Other features and aspects will be apparent from the following detailed description, the drawings, and the claims.

### BRIEF DESCRIPTION OF DRAWINGS

FIG. 1 is a perspective view of a camera module according to an embodiment of the present disclosure.

FIG. 2 is a partially cut-away perspective view of a camera module according to an embodiment of the present disclosure.

FIG. 3 is a cross-sectional view of a camera module according to an embodiment of the present disclosure.

FIG. 4 is an exploded perspective view of a camera module according to an embodiment of the present disclosure.

FIG. 5 is a view of FIG. 4 viewed in another direction.

FIG. 6 is a perspective view of a first lens module and a first reflective module according to an embodiment of the present disclosure.

FIG. 7 is a view of FIG. 6 viewed in another direction.

FIG. 8 is a bottom perspective view of the first lens module a holder according to an embodiment of the present disclosure.

FIG. 9 is an exploded perspective view of the holder and a guide member according to an embodiment of the present disclosure.

FIG. 10 is a partially cut-away perspective view of a housing according to an embodiment of the present disclosure.

FIG. 11 is a plan view of the housing according to an embodiment of the present disclosure.

FIG. 12 is a diagram illustrating the first lens module, holder and reflective member rotating about the second rotation axis.

FIG. 13 is a diagram illustrating the first lens module, holder, reflective member and guide member rotating about the first rotation axis.

FIG. 14 is a perspective view illustrating a second lens module separated in a camera module according to an embodiment of the present disclosure.

FIG. 15 is a bottom perspective view of the second lens module.

FIG. 16 is an exploded perspective view illustrating an image sensor module separated in the camera module according to an embodiment of the present disclosure.

FIG. 17 is a perspective view of the reflective member of the first reflective module according to another embodiment of the present disclosure.

FIG. 18 is a perspective view illustrating the second lens module separated in a camera module according to another embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

The present disclosure relates to a camera module, which may be mounted on portable electronic devices such as mobile communication terminals, smartphones, or tablet PCs.

An aspect of the present disclosure is to provide a reflective module that can prevent resolution deterioration during shake correction and a camera module comprising the same.

According to another aspect of the present disclosure, the reflective module and a camera module comprising the same may prevent resolution deterioration during the shake correction.

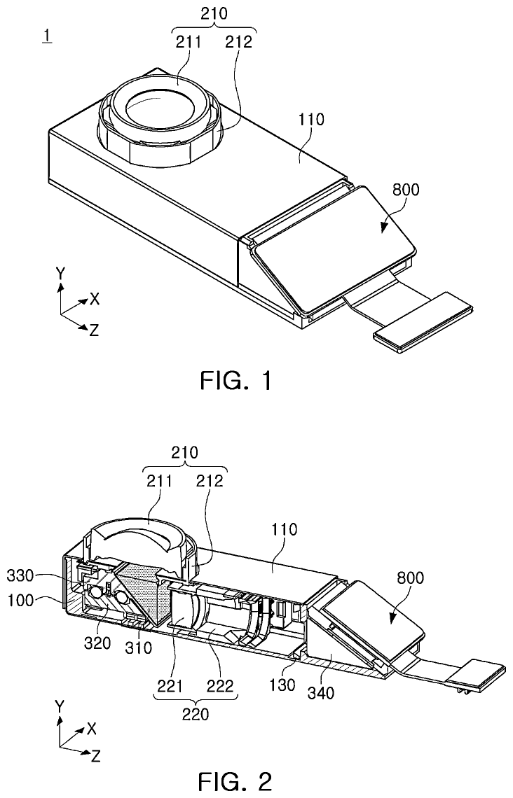

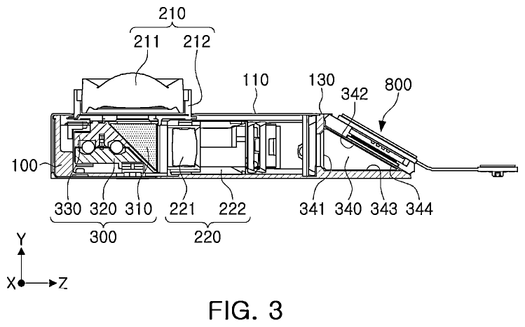

FIG. 1 is a perspective view of a camera module; FIG. 2 is a partially cut-away perspective view of the camera module; and FIG. 3 is a cross-sectional view of a camera module according to an embodiment of the present disclosure.

Referring to FIGS. 1 to 3, a camera module 1 may include a first lens module 210, a first reflective module 300, and a housing 100.

The first lens module 210 includes at least one lens, which may have a first optical axis (Y-axis). The first optical axis (Y-axis) may extend in the upper and lower direction with respect to FIG. 3.

In an embodiment, the first lens module 210 may include a first lens barrel 211 and a first lens holder 212. At least one lens is disposed in the first lens barrel 211, and the first lens barrel 211 may be combined with the first lens holder 212.

The first lens module 210 may be disposed in front of the first reflective module 300. Here, ‘in front’ may mean the positive first optical axis (Y-axis) direction (+Y-axis direction) with respect to the first reflective module 300. For example, the first lens module 210 may be disposed higher than the first reflective module 300 in the direction of the first optical axis (Y-axis).

The first lens module 210 may be combined with the first reflective module 300. For example, the first lens holder 212 of the first lens module 210 may be coupled to a holder 330 of the first reflective module 300.

The first lens module 210 and the first reflective module 300 are disposed in the housing 100.

In an embodiment, the camera module 1 may further include a second lens module 220. The first reflective module 300 is disposed between the first lens module 210 and the second lens module 220. The second lens module 220 includes a plurality of lenses, and the plurality of lenses are arranged along a second optical axis (Z-axis).

The first optical axis (Y-axis) of the first lens module 210 and the second optical axis (Z-axis) of the second lens module 220 may be formed to be perpendicular to each other.

The first lens module 210 includes one or more lenses, and the second lens module 220 includes a plurality of lenses.

One or more lenses of the first lens module 210 may be circular when viewed in the first optical axis (Y-axis) direction. At least one lens among the plurality lenses of the second lens module 220 may be non-circular when viewed in the second optical axis (Z-axis) direction. For example, a non-circular lens may have different lengths in two directions perpendicular to the second optical axis (Z-axis) and perpendicular to each other. In an embodiment, the non-circular lens may have a length in the first axis (X-axis) direction perpendicular to both the first optical axis (Y-axis) direction and the second optical axis (Z-axis) direction longer than a length in the first optical axis (X-axis) direction.

The first lens module 210 and the first reflective module 300 may be configured to rotate together for shake correction. The second lens module 220 may be moved in the second optical axis (Z-axis) direction for focus adjustment.

The camera module 1 may further include an image sensor module 800.

The image sensor module 800 includes a sensor housing 830, an image sensor 810, a printed circuit board 820, and may further include an infrared cut filter 850.

The infrared cut filter 850 may be mounted on the sensor housing 830. The infrared cut filter 850 serves to block light in the infrared region among the light that has passed through the second lens module 220.

The printed circuit board 820 is coupled to the sensor housing 830, and the image sensor 810 is disposed on the printed circuit board 820.

Light passing through the second lens module 220 is received by the image sensor module 800 (e.g., image sensor 810).

The camera module 1 may further include a first light-blocking plate 130. The first light-blocking plate 130 is disposed in the housing 100 and serves to prevent a flare phenomenon from occurring due to unintentional reflection of light inside the housing 100.

The first light-blocking plate 130 may be disposed in a space between the second lens module 220 and the image sensor module 800. Additionally, the first light-blocking plate 130 may be disposed closer to the image sensor module 800 than the second lens module 220.

Therefore, even if an unintentional reflection of light occurs inside the housing 100, by the first light-blocking plate 130, the light diffusely reflected can be prevented from entering the image sensor 810, thus suppressing a flare phenomenon.

The camera module 1 may further include a second reflective module 340. The second reflective module 340 is disposed between the second lens module 220 and the image sensor module 800. Additionally, the second reflective module 340 may be disposed between the first light-blocking plate 130 and the image sensor module 800.

The second reflective module 340 may have one or more reflection surfaces. Since the light passing through the second lens module 220 is reflected one or more times by the second reflective module 340 and enters the image sensor 810, a long optical path may be formed within a limited space.

In an embodiment, the second reflective module 340 may have a triangular pillar shape. The second reflective module 340 may include an incident surface 341 on which light is incident, a first reflection surface 342 that reflects light passing through the incident surface 341, a second reflection surface 343 that reflects the light reflected from the first reflection surface 342, and an emission surface 344 where the light reflected from the second reflection surface 343 may exits. Light passing through the emission surface 344 may be incident on the image sensor 810.

The camera module 1 may further include a case 110. The case 110 is coupled to the housing 100 to cover the upper part of the housing 100. The case 110 has an opening, and the first lens module 210 may be disposed in the opening.

Meanwhile, at least a portion of the first lens module 210 may be disposed to protrude outside the housing 100 and the case 110.

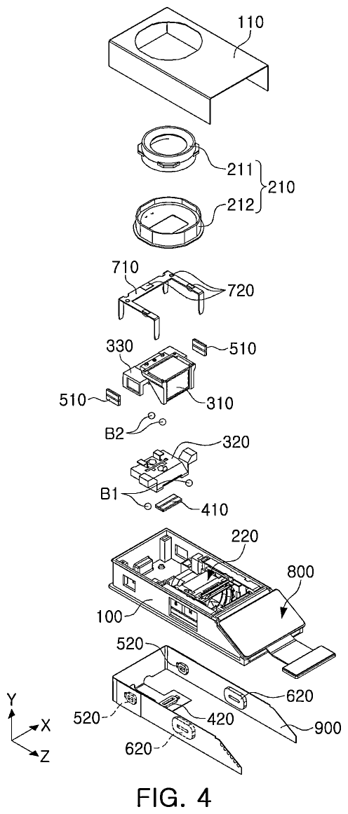

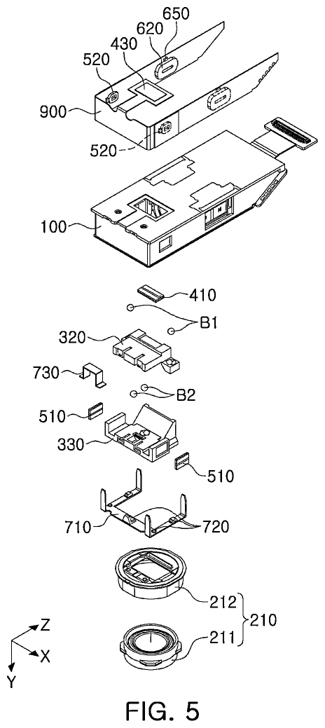

FIG. 4 is an exploded perspective view of a camera module according to an embodiment of the present disclosure, and FIG. 5 is a view of FIG. 4 viewed in another direction.

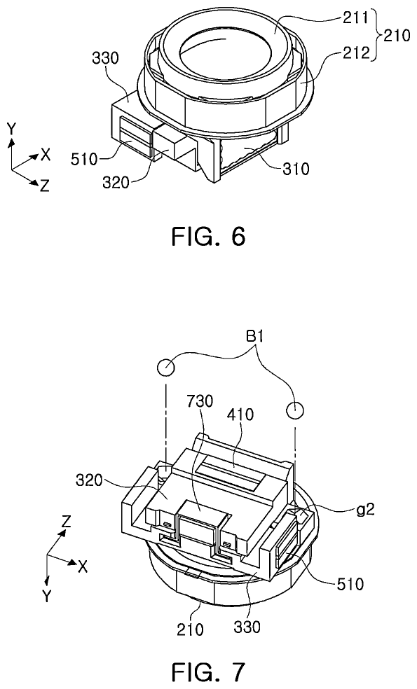

Additionally, FIG. 6 is a perspective view of a first lens module and a first reflective module according to an embodiment of the present disclosure. FIG. 7 is a view of FIG. 6 viewed in another direction.

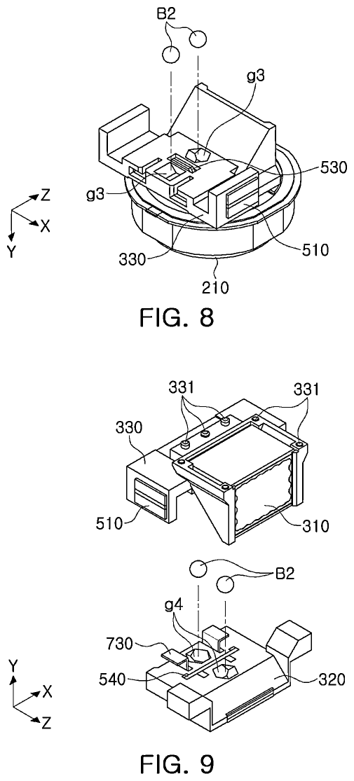

Additionally, FIG. 8 is a bottom perspective view of a first lens module and a holder. FIG. 9 is an exploded perspective view of the holder and the guide member, according to an embodiment of the present disclosure.

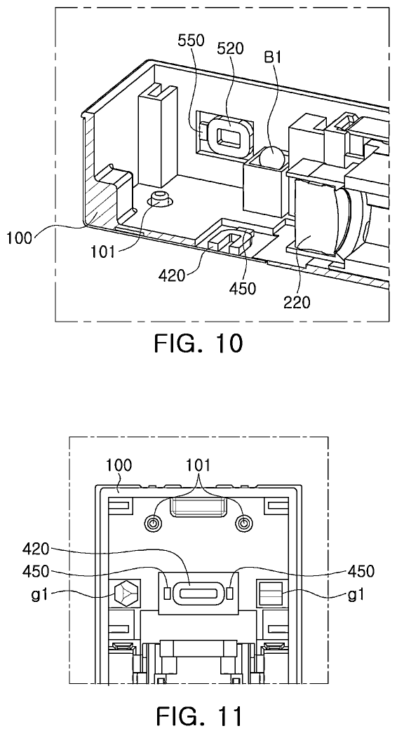

Additionally, FIG. 10 is a partially cut-away perspective view of the housing. FIG. 11 is a plan view of the housing, according to an embodiment of the present disclosure.

Referring to FIGS. 4 to 11, the first reflective module 300 includes a reflection member 310, a holder 330, and a guide member 320.

The reflection member 310 has a reflection surface reflecting light that has passed through the first lens module 210. For example, the reflection member 310 may be a prism or mirror.

When the reflection member 310 is a prism, the reflection member 310 may be in the form of a rectangular parallelepiped or a cube divided in two diagonally. The prism may include an entrance surface through which light is incident, a reflection surface through which light passing through the incident surface is reflected, and an exit surface through which light reflected from the reflection surface is exited.

The reflection member 310 is mounted on the holder 330. A first lens module 210 may be disposed in front of the reflection member 310. In an embodiment, the first lens module 210 may be mounted on the holder 330.

The holder 330 is rotatably disposed on the guide member 320. The guide member 320 is rotatably disposed in the housing 100.

The guide member 320 may be rotated using the first axis (X-axis), perpendicular to both the first optical axis (Y-axis) and the second optical axis (Z-axis), as a rotation axis. For example, the guide member 320 may be rotated relative to the housing 100 using the first axis (X-axis) as a rotation axis. The first lens module 210 and the holder 330 may also be rotated together with the guide member 320. Meanwhile, the first axis (X-axis) may also be referred to as a first rotation axis.

The holder 330 may be rotated using the second optical axis (Z-axis), perpendicular to the first axis (X-axis) as a rotation axis. For example, the holder 330 may be rotated relative to the guide member 320 using the second optical axis (Z-axis) as a rotation axis. The first lens module 210 may be rotated together with the holder 330. Meanwhile, the second optical axis (Z-axis) may also be referred to as a second rotation axis.

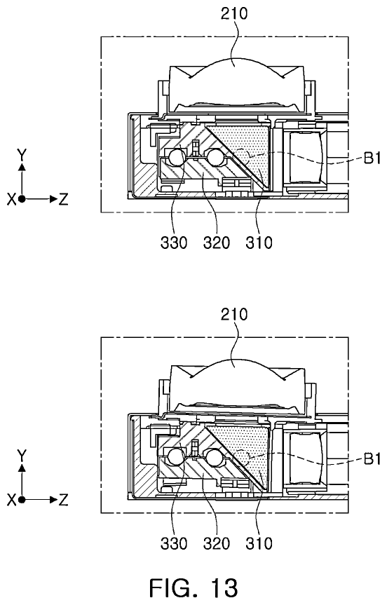

A first driving unit 400 may be provided to rotate the first reflective module 300. The first driving unit 400 includes a first magnet 410 and a first coil 420. The guide member 320 may be rotated relative to the housing 100 based on the first axis (X-axis) by the first driving unit 400. As the holder 330 and the first lens module 210 are disposed on the guide member 320, the holder 330 and the first lens module 210 may also be rotated together with the guide member 320 (see FIG. 13).

The first magnet 410 may be mounted on the guide member 320. As an example, the first magnet 410 may be mounted on one surface of the guide member 320. The one surface of the guide member 320 may mean a surface facing the housing 100 in the first optical axis (Y-axis) direction. For example, the one surface of the guide member 320 may be a lower surface of the guide member 320.

The first magnet 410 may be magnetized so that one surface (e.g., the surface facing the first coil 420) may have both an N-pole and an S-pole. In an embodiment, the one surface of the first magnet 410 facing the first coil 420 may be provided with an N-pole, a neutral region, and an S-pole in order in the second optical axis (Z-axis) direction.

The first coil 420 may be disposed in a position facing the first magnet 410. In an embodiment, the first coil 420 may be arranged to face the first magnet 410 in the first optical axis (Y-axis) direction.

The first coil 420 is disposed on a substrate 900, and the substrate 900 is mounted on the housing 100 so that the first magnet 410 and the first coil 420 face each other in the first optical axis (Y-axis) direction.

The housing 100 is provided with a through-hole penetrating the housing 100 in the first optical axis (Y-axis) direction, and the first coil 420 is disposed in the through-hole so as to directly face the first magnet 410.

During shake correction, the first magnet 410 is a moving member mounted on the guide member 320 and rotates with the guide member 320, and the first coil 420 is a fixed member fixed to the substrate 900.

When power is applied to the first driving unit 400, the first driving unit 400 may generate the driving force desired to rotate the guide member 320 around the first axis (X-axis) as the rotation axis. For example, the first driving unit 400 may generate driving force in the direction of the second optical axis (Z-axis).

A first ball member B1 may be disposed between the guide member 320 and the housing 100. The first ball member B1 may be disposed between the guide member 320 and the housing 100 to form the rotation axis of the guide member 320.

The first ball member B1 may include a plurality of balls spaced apart in the first axis (X-axis) direction. A virtual line connecting the plurality of balls of the first ball member B1 in the first axis (X-axis) direction may be spaced apart or offset from the first magnet 410 in the first optical axis (Y-axis) direction.

In an embodiment, the first magnet 410 and the first coil 420 may be spaced apart from the first ball member B1 in the first optical axis (Y-axis) direction. When driving force is generated in the direction of the second optical axis (Z-axis) by the first magnet 410 and the first coil 420, the guide member 320 may rotate based on the rotation axis formed by the first ball member B1.

A virtual line connecting the plurality of balls of the first ball member B1 in the first axis (X-axis) direction may pass through the reflective surface of the reflection member 310.

In an embodiment, when viewed in the first axis (X-axis) direction, a line extending the first optical axis (Y-axis) of the first lens module 210 may be disposed between both ends of the plurality of balls of the first ball member B1. Here, both ends of the plurality of balls of the first ball member B1 may mean both ends in the direction of the second optical axis (Z-axis).

Attractive force may act between the guide member 320 and the housing 100. In an embodiment, the first pulling yoke 430 may be disposed at a position facing the first magnet 410 in the first optical axis (Y-axis) direction.

The first pulling yoke 430 may be disposed on the substrate 900. For example, the first coil 420 may be disposed on an inner surface of the substrate 900, and the first pulling yoke 430 may be disposed on the outer surface of the substrate 900.

The first magnet 410 and the first pulling yoke 430 may generate attractive force between each other. For example, the first pulling yoke 430 may be formed of a magnetic material. Attractive force acts between the first magnet 410 and the first pulling yoke 430 in the direction of the first optical axis (Y-axis).

The first ball member B1 may be maintained in contact with the guide member 320 and the housing 100 due to the attractive force between the first magnet 410 and the first pulling yoke 430.

A first guide groove g1 and a second guide groove g2 may be disposed on surfaces where the guide member 320 and the housing 100 face each other (e.g., the surfaces facing in the first optical axis (Y-axis) direction). For example, a first guide groove g1 may be disposed in the housing 100, and a second guide groove g2 may be disposed in the guide member 320. The first guide groove g1 and the second guide groove g2 may face each other in the first optical axis (Y-axis) direction.

The first guide groove g1 may include a plurality of grooves spaced apart in the first axis (X-axis) direction, and the second guide groove g2 may include a plurality of grooves spaced apart in the first axis (X-axis) direction.

The first ball member B1 may be disposed between the first guide groove g1 and the second guide groove g2 to form the rotation axis of the guide member 320.

One of the plurality of grooves of the first guide groove g1 may be in three-point contact with the first ball member B1, and the other one of the plurality of grooves of the first guide groove g1 may be in two-point contact with the first ball member B1. For example, referring to FIG. 11, a groove located on the left of the plurality of grooves of the first guide groove g1 may contact the first ball member B1 at three-points, and a groove located on the right of the plurality of grooves of the first guide groove g1 may contact the first ball member B1 at two-points.

In addition, each of the plurality of grooves of the second guide groove g2 may contact the first ball member B1 at three-points. It may be also possible to reverse the shape of the first guide groove g1 and the shape of the second guide groove g2.

In an embodiment, the camera module 1 may detect the position of the guide member 320. To this end, the first position sensor 450 is provided. The first position sensor 450 may be disposed in the position facing the first magnet 410 of the first driving unit 400 (e.g., the position facing the first optical axis (Y-axis) direction).

Therefore, when the guide member 320 is rotated with the first axis (X-axis), the position of the guide member 320 may be detected through the first position sensor 450.

The first position sensor 450 may be a hall sensor. The first position sensor 450 may include two hall sensors, which may be spaced apart in the first axis (x-axis) direction. For example, two hall sensors may be spaced apart on one side and the other side of the first coil 420.

In the housing 100, a through-hole that penetrates the housing 100 in the direction of the first optical axis (Y-axis) may be disposed, and a substrate 900 may be disposed on the lower surface of the housing 100 to cover the through-hole. In addition, the first coil 420 and the first position sensor 450 may be disposed on the substrate 900.

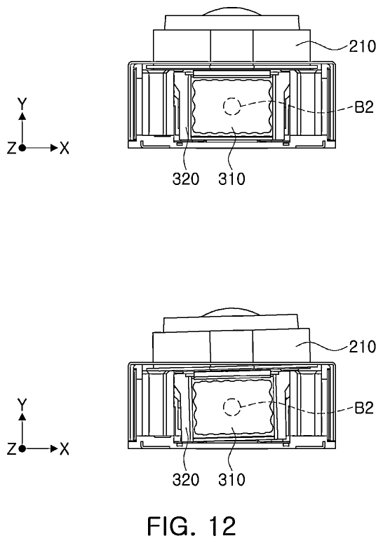

The second driving unit 500 may be provided to rotate the holder 330. The second driving unit 500 includes a second magnet 510 and a second coil 520. The holder 330 may be rotated based on the second optical axis (Z-axis) by the second driving unit 500. Since the first lens module 210 is disposed in the holder 330, the first lens module 210 may be rotated with the holder 330 (see FIG. 12).

The second magnet 510 may be mounted on the holder 330. For example, the second magnet 510 may be mounted on the side of the holder 330. In one embodiment, the second magnet 510 may include two magnets, and one magnet may be mounted on one side and other sides of the holder 330. One side of the holder 330 and the other side of the holder 330 may be spaced apart in the first axis (X-axis) direction.

The second magnet 510 may be mounted on the holder 330. For example, the second magnet 510 may be mounted on the side surface of the holder 330. In an embodiment, the second magnet 510 may include two magnets, and one magnet may be mounted on one side surface and the other side surface of the holder 330, respectively. The one side surface of the holder 330 and the other side surface of the holder 330 may be spaced apart in the first axis (X-axis) direction.

The second magnet 510 may be magnetized so that one surface (e.g., the surface facing the second coil 520) may have both an N-pole and an S-pole. In an embodiment, the one surface of the second magnet 510 facing the second coil 520 may be provided with an N-pole, neutral region, and S-pole according to the first optical axis (Y-axis) direction.

The second coil 520 may be disposed in a position facing the second magnet 510. In an embodiment, the second coil 520 may be disposed to face the second magnet 510 in the first axis (X-axis) direction.

The second coil 520 is disposed on the substrate 900, and the substrate 900 is mounted on the housing 100 so that the second magnet 510 and the second coil 520 face the first axis (X-axis).

The housing 100 is provided with a through-hole that penetrates the housing 100 in the direction of the first axis (X-axis), and the second coil 520 is disposed in the through-hole and may face the second magnet 510 directly.

During shaking correction, the second magnet 510 is a moving member mounted on the holder 330 and rotates with the holder 330, and the second coil 520 is a fixed member fixed to the substrate 900.

In an embodiment, the second coil 520 may include two coils. Two coils may be spaced apart in the first axis (X-axis) direction.

When the power is applied to the second driving unit 500, the second driving unit 500 may generate the driving force desired for the rotation of the second optical axis of the holder 330 as a rotation axis. For example, the second driving unit 500 may generate driving force in the direction of the first optical axis (Y-axis).

The second ball member B2 may be disposed between the holder 330 and the guide member 320. The second ball member B2 may be disposed between the holder 330 and the guide member 320 to form a rotation axis of the holder 330.

The second ball member B2 includes a plurality of balls spaced apart in the direction of the second optical axis (Z-axis). The virtual line of a plurality of balls of the second ball member B2 in the direction of second optical axis (Z-axis) may be spaced apart from the second magnet 510 in the first axis (X-axis) direction.

In an embodiment, the second magnet 510 and the second coil 520 may be spaced apart from the second ball member B2 in the first axis (X-axis) direction. When driving force is generated in the first optical axis (Y-axis) direction by the second magnet 510 and the second coil 520, the holder 330 may be configured to rotate about the rotation axis, formed by the second ball member B2.

The virtual line of the plurality of balls of the second ball member B2 in the direction of the second optical axis (Z-axis) may pass through the reflective surface of the reflection member 310.

In an embodiment, when viewed in the first axis (X-axis) direction, a line extending the second optical axis of the second lens module 220 may be disposed between both ends of the plurality of balls of the second ball member B2.

Attractive force may act between the holder 330 and the guide member 320. In an embodiment, a first pulling magnet 530 may be disposed on one of the holder 330 or the guide member 320, and a second pulling yoke 540 may be disposed on the other thereof. In another embodiment, it may be able to dispose the first pulling magnet 530 on both the holder 330 and the guide member 320.

One surface of the first pulling magnet 530 (e.g., the surface facing the second pulling yoke 540) may be magnetized in the form of an N-pole, neutral region, and S-pole in the second optical axis (Z-axis) direction.

The first pulling magnet 530 and the second pulling yoke 540 may face each other in the first optical axis (Y-axis) direction. In an embodiment, the first pulling magnet 530 may be disposed on the lower surface of the holder 330, and the second pulling yoke 540 may be disposed on the upper surface of the guide member 320.

The first pulling magnet 530 and the second pulling yoke 540 may generate attractive force between each other. For example, the second pulling yoke 540 may be made of a magnetic material. Attractive force acts between the first pulling magnet 530 and the second pulling yoke 540 in the direction of the first optical axis (Y-axis).

The second ball member B2 may be maintained in contact with the holder 330 and the guide member 320 due to the attractive force between the first pulling magnet 530 and the second pulling yoke 540.

Meanwhile, the length of the second pulling yoke 540 in the first axis (X-axis) direction may be longer than the length of the first pulling magnet 530 in the first axis (X-axis) direction.

A third guide groove g3 and a fourth guide groove g4 may be disposed on the surfaces where the holder 330 and the guide member 320 face each other (e.g., the surfaces facing each other in the first optical axis (Y-axis) direction).

The third guide groove g3 includes a plurality of grooves spaced apart in the second optical axis (Z-axis) direction, and the fourth guide groove g4 includes a plurality of grooves spaced apart in the second optical axis (Z-axis) direction.

The second ball member B2 may be disposed between the third guide groove g3 and the fourth guide groove g4 to form the rotation axis of the holder 330.

One of the plurality of grooves of the third guide groove g3 may be in three-point contact with the second ball member B2, and the other one of the plurality of grooves of the third guide groove g3 may be in two-point contact with the second ball member B2. For example, referring to FIG. 8, a groove located on the right of the plurality of grooves of the third guide groove g3 may contact the second ball member B2 at three points, and a groove located on the left of the plurality of grooves of the third guide groove g3 may be in two-point contact with the second ball member B2.

In addition, each of the plurality of grooves of the fourth guide groove g4 may be in three-point contact with the second ball member B2. It is also possible to reverse the shapes of the third guide groove g3 and the fourth guide groove g4 each other.

In one embodiment, the camera module 1 can detect the position of the holder 330. For this purpose, a second position sensor 550 is provided. The second position sensor 550 may be disposed at a position facing the second magnet 510 (e.g., a position facing the first axis (X-axis) direction).

Therefore, when the holder 330 is rotated with the second optical axis (Z-axis) as the rotation axis, the position of the holder 330 can be detected through the second position sensor 550.

The second position sensor 550 may be a hall sensor.

A through-hole penetrating the housing 100 in the first axis (X-axis) direction may be disposed in the housing 100, and the substrate 900 that covers the through-hole may be disposed on a side surface of the housing 100. Additionally, the second coil 520 and the second position sensor 550 may be disposed on the substrate 900.

Meanwhile, although not illustrated in the drawing, a spacer may be disposed on the lower surface of the first lens module 210 (e.g., the lower surface of the first lens holder 212 facing the reflection member 310). The spacer has an entrance hole through which light passes, and the entrance hole may be non-circular. For example, the entrance hole may be shaped like a running track. That is, an inner surface of the spacer forming the entrance hole may include two planes extending parallel to each other and two curved surfaces connecting the two planes.

The inner surface of the spacer may have a waveform in which concave and convex shapes are repeated, thereby preventing the flare phenomenon.

Meanwhile, referring to FIGS. 4 and 5, the camera module 1 may further include a first stopper 710. The first stopper 710 may be coupled to the housing 100 to cover at least a portion of the first reflective module 300. For example, the first stopper 710 may cover at least a portion of the upper surface of the holder 330. The first stopper 710 and the holder 330 may be arranged to be spaced apart in the first optical axis (Y-axis) direction.

Since the first stopper 710 is disposed to be spaced apart from the first reflective module 300, it is possible to prevent the first reflective module 300 from being separated from the housing 100 due to external impacts or the like, without interfering with the rotation of the first reflective module 300.

A buffer member 720 having elastic force may be coupled to the first stopper 710. The buffer member 720 may be disposed on at least one of one surface and the other surface of the first stopper 710. One side of the first stopper 710 may be a surface facing the case 110 in the first optical axis (Y-axis) direction, and the other surface of the first stopper 710 may be a surface that faces the holder 330 in the first optical axis (Y-axis) direction.

Meanwhile, a second stopper 730 may be disposed on the guide member 320. The second stopper 730 is fixed to the guide member 320, and a portion of the second stopper 730 may extend toward the holder 330. A receiving portion in which a portion of the second stopper 730 is accommodated may be disposed in the holder 330. The receiving portion may be groove or hole shaped.

A portion of the second stopper 730 is disposed in the receiving portion of the holder 330 and may be arranged to be spaced apart from the receiving portion. An end of a portion of the second stopper 730 extended with a bend within the receiving portion. The portion of the second stopper 730 and the receiving portion of the holder 330 may have shapes corresponding to each other.

In an embodiment, an end of a portion of the second stopper 730 and the receiving portion may face each other in the first optical axis (Y-axis) direction.

Accordingly, the second stopper 730 may prevent the holder 330 from being separated from the guide member 320 due to external shocks, etc., without interfering with the rotation of the holder 330.

A buffer member 101 may be disposed on at least one of the surfaces of the guide member 320 and the housing 100 facing each other (e.g., the surface facing the first lens module 210 and the first optical axis (Y-axis)).

For example, referring to FIGS. 10 and 11, a buffer member 101 having elastic force may be disposed on the inner bottom surface of the housing 100. The inner bottom surface of the housing 100 may be a surface facing the guide member 320 in the direction of the first optical axis (Y-axis). As another example, the buffer member 101 may be disposed on the lower surface of the guide member 320 (a surface facing the inner bottom surface of the housing 100 in the direction of the first optical axis (Y-axis)).

Therefore, when rotating about the first axis (X-axis) of the guide member 320, the rotation range may be limited, and when the guide member 320 and the housing 100 collide with each other, the amount of impact and noise may be reduced.

At least one of the surfaces of the holder 330 and the first stopper 710 facing each other (e.g., the surface facing the first lens module 210 and the first optical axis (Y-axis)) may disposed with buffer members 331 and 720.

For example, referring to FIG. 9, a buffer member 331 may be disposed on the upper surface of the holder 330 (the surface facing the lower surface of the first stopper 710 in the first optical axis (Y-axis) direction). Referring to FIG. 5, a buffer member 720 may be disposed on the lower surface of the first stopper 710. The buffer members 331 and 720 may be formed of an elastic material.

Therefore, when rotating about the second optical axis (Z-axis) of the holder 330, the rotation range may be limited, and when the holder 330 and the first stopper 710 collide with each other, the amount of impact and noise can be reduced.

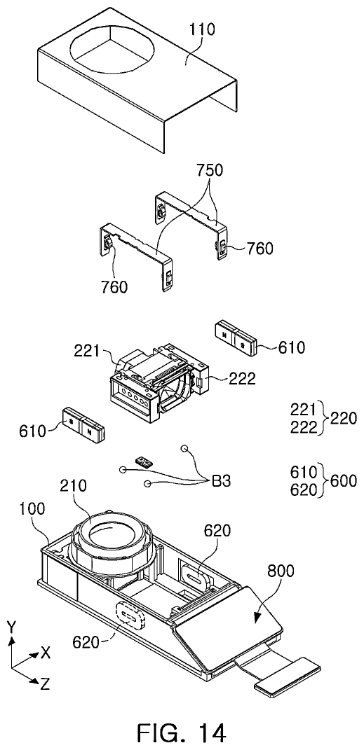

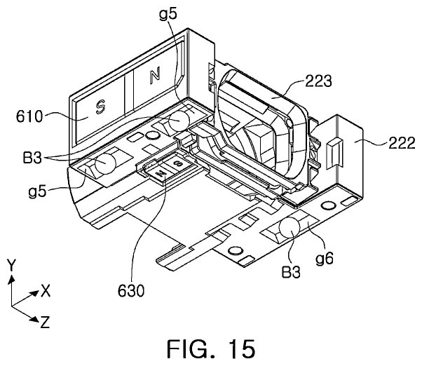

FIG. 14 is a perspective view illustrating a second lens module separated in a camera module according to an embodiment of the present disclosure. FIG. 15 is a bottom perspective view of the second lens module.

Referring to FIG. 14, the second lens module 220 may be disposed between the first reflective module 300 and the image sensor module 800.

The second lens module 220 may be moved in the second optical axis (Z-axis) direction for focus adjustment.

In an embodiment, the second lens module 220 includes a second lens barrel 221 and a second lens holder 222. A plurality of lenses are disposed in the second lens barrel 221, and the second lens barrel 221 may be combined with the second lens holder 222.

The camera module 1 may include a third driving unit 600 to move the second lens module 220 in the second optical axis (Z-axis) direction.

The third driving unit 600 includes a third magnet 610 and a third coil 620. The third magnet 610 and the third coil 620 may be disposed to face each other in a direction perpendicular to the second optical axis (Z-axis) direction.

The third magnet 610 is mounted on the second lens module 220. As an example, the third magnet 610 may be disposed on a side surface of the second lens module 220.

In an embodiment, the third magnet 610 may include two magnets, and one magnet may be mounted on one side surface and the other side surface of the second lens module 220, respectively. The one side surface and the other side surface of the second lens module 220 may be spaced apart in the first axis (X-axis) direction.

The third magnet 610 may be magnetized so that one surface (e.g., the surface facing the third coil 620) may have both an N-pole and an S-pole. For example, the one surface of the third magnet 610 facing the third coil 620 may sequentially include an N-pole, a neutral region, and an S-pole in order in the second optical axis (Z-axis) direction.

The third coil 620 is disposed to face the third magnet 610. For example, the third coil 620 may be arranged to face the third magnet 610 in a direction perpendicular to the second optical axis (Z-axis) direction (e.g., in the first axis (X-axis) direction).

The third coil 620 is disposed on the substrate 900, and the substrate 900 is mounted on the housing 100 so that the third magnet 610 and the third coil 620 face each other in the first axis (X-axis) direction. In an embodiment, the third coil 620 may include two coils spaced apart in the first axis (X-axis) direction.

The housing 100 is provided with a through-hole penetrating the housing 100, and the third coil 620 disposed on the substrate 900 can directly face the third magnet 610 through the through-hole.

During focus adjustment, the third magnet 610 is a moving member that is mounted on the second lens module 220 and moves in the direction of the second optical axis (Z-axis) together with the second lens module 220, and the third coil 620 is a fixing member fixed to the substrate 900.

When power is applied to the third coil 620, the second lens module 220 may be moved in the second optical axis (Z-axis) direction by the electromagnetic force between the third magnet 610 and the third coil 620.

A third ball member B3 is disposed between the second lens module 220 and the housing 100, and the second lens module 220 may be guided by the third ball member B3 and moved in the direction of the second optical axis (Z-axis). The third ball member B3 may include a plurality of balls.

A second pulling magnet 630 may be disposed on the lower surface of the second lens module 220, and a third pulling yoke may be disposed on the inner bottom surface of the housing 100. In another embodiment, the second pulling magnet 630 may be disposed on both the second lens module 220 and the housing 100.

The second pulling magnet 630 may be disposed closer to the one side surface of the second lens module 220. That is, the second pulling magnet 630 may be disposed closer to the one side surface of the second lens module 220 than to the other side surface of the second lens module 220. Additionally, the second pulling magnet 630 may be disposed between the one side surface of the second lens module 220 and the second optical axis (Z-axis).

The second pulling magnet 630 and the third pulling yoke may be disposed to face each other in the first optical axis (Y-axis) direction.

The second pulling magnet 630 and the third pulling yoke may generate attractive force between each other. For example, an attractive force acts between the second pulling magnet 630 and the third pulling yoke in the direction of the first optical axis (Y-axis).

The third ball member B3 may be in contact with the second lens module 220 and the housing 100, respectively, by the attractive force of the second pulling magnet 630 and the third pulling yoke.

Some of the plurality of balls of the third ball member B3 may be disposed closer to the one side surface of the second lens module 220, and the remaining balls of the third ball member B3 may be disposed closer to the other side surface of the second lens module 220. The number of balls disposed between the one side surface of the second lens module 220 and the second optical axis (Z axis) is greater than the number of balls disposed between the other side of the second lens module 220 and the second optical axis (Z-axis).

In an embodiment, the third ball member B3 may include three balls. Two of the three balls are disposed between the one side surface of the second lens module 220 and the second optical axis (Z axis). The remaining one of the three balls may be disposed between the other side surface of the second lens module 220 and the second optical axis (Z-axis).

The two balls disposed between the one side surface of the second lens module 220 and the second optical axis (Z-axis) may be spaced apart in the second optical axis (Z-axis) direction.

A fifth guide groove g5 and a sixth guide groove g6 may be disposed on surfaces where the second lens module 220 and the housing 100 face each other. For example, a fifth guide groove g5 is disposed on one side of the surfaces where the second lens module 220 and the housing 100 face each other, and a sixth guide groove g6 may be disposed on the other side of the surfaces of the second lens module 220 and the housing 100 facing each other.

The fifth guide groove g5 and the sixth guide groove g6 may be spaced apart in a direction perpendicular to the second optical axis (Z-axis) (e.g., in the first axis (X-axis) direction).

The fifth guide groove g5 and the sixth guide groove g6 extend in a direction parallel to the second optical axis (Z-axis).

Some of the plurality of balls of the third ball member B3 are disposed in the fifth guide groove g5, and the rest of the plurality of balls of the third ball member B3 are disposed in the sixth guide groove g6.

The number of contact points between some of the plurality of balls of the third ball member B3 and the fifth guide groove g5 is greater than the number of contact points between the rest of the plurality of balls of the third ball member B3 and the sixth guide groove g6.

The fifth guide groove g5 may be disposed closer to one side surface of the second lens module 220 than the sixth guide groove g6.

The second pulling magnet 630 may be disposed closer to the fifth guide groove g5 than the sixth guide groove g6.

In an embodiment, the camera module 1 may detect the position of the second lens module 220. For this purpose, a third position sensor 650 is provided. The third position sensor 650 may be disposed at a position facing the third magnet 610 of the third driving unit 600 (e.g., a position facing the first axis (X-axis) direction).

Accordingly, when the second lens module 220 moves in the second optical axis (Z-axis) direction, the position of the second lens module 220 can be detected through the third position sensor 650.

The third position sensor 650 may be a hall sensor.

Meanwhile, the second lens module 220 may further include a second light-blocking plate 223. The second light-blocking plate 223 may be coupled to the second lens module 220.

One side surface and the other side surface of the second lens module 220 may each extend in the direction of the second optical axis from the second lens module 220 (Z-axis). A portion of one side surface of the second lens module 220 and a portion of the other side surface of the second lens module 220 may face each other in the first axis (X-axis) direction. A space may be formed between a portion of one side surface of the second lens module 220 and a portion of the other side surface of the second lens module 220.

The second light-blocking plate 223 may be disposed in a space between a portion of one side surface of the second lens module 220 and a portion of the other side surface of the second lens module 220.

The second light-blocking plate 223 serves to prevent unintentional reflection of light passing through the second lens module 220 inside the housing 100. Therefore, the flare phenomenon can be suppressed.

The camera module 1 may further include a third stopper 750. The third stopper 750 may be coupled to the housing 100 and may cover at least a portion of the second lens module 220.

In an embodiment, the third stopper 750 may be disposed to face the upper surface of the second lens module 220 in the first optical axis (Y-axis) direction. One side and the other side of the third stopper 750 are each bent and extended in the first optical axis (Y-axis) direction and may face the second lens module 220 in the second optical axis (Z-axis) direction.

A buffer member 760 having elastic force may be coupled to the third stopper 750. For example, a buffer member 760 may be mounted on one side and the other side of the third stopper 750 that faces the second lens module 220 and the second optical axis (Z-axis) direction, respectively.

Additionally, a buffer member may be mounted on at least one of the surfaces of the third stopper 750 and the second lens module 220 facing each other in the first optical axis (Y-axis) direction.

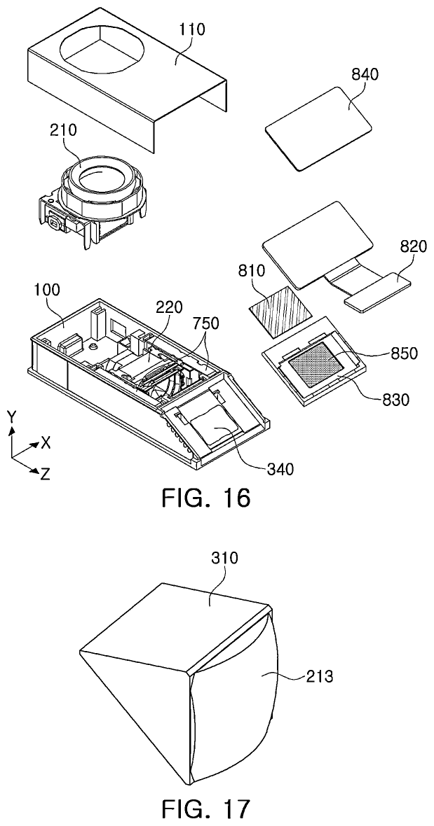

FIG. 16 is a partial exploded perspective view illustrating the image sensor module separated from the camera module according to an embodiment of the present disclosure.

The camera module 1 may further include a second reflective module 340. The second reflective module 340 may be disposed between the second lens module 220 and the image sensor 810. The second reflective module 340 may reflect light that has passed through the second lens module 220 at least once.

In an embodiment, the second reflective module 340 may have a plurality of reflective surfaces that reflect light a plurality of times, passing through the second lens module 220.

In an embodiment, the second reflective module 340 may have a triangular pillar shape. The second reflective module 340 may include an incident surface 341 where light is incident, a first reflective surface 342 that reflects light passing through the incident surface 341, a second reflective surface 343 that reflects the light reflected from the first reflective surface 342, and an exit surface 344 through which light reflected from the second reflective surface 343 exits. Light passing through the exit surface 344 may be incident on the image sensor 810.

The inclination angle of the reflective surface of the first reflection module 300 and the inclination angle of the first reflective surface 342 of the second reflective module 340 may be different. For example, the inclination angle of the first reflective surface 342 of the second reflective module 340 may be smaller than the inclination angle of the reflective surface of the first reflective module 300. Here, ‘inclination angle’ may mean an inclination angle with the inner bottom surface of the housing 100.

In an embodiment, the inclination angle of the reflective surface of the first reflective module 300 may be 45°, and the inclination angle of the first reflective surface 342 of the second reflective module 340 may be 30°.

The image sensor module 800 includes the image sensor 810, the printed circuit board 820, and the sensor housing 830. Additionally, the image sensor module 800 may further include a reinforcement plate 840 and the infrared cut filter 850.

The image sensor module 800 may be mounted at an angle with respect to the housing 100. For example, the housing 100 may be provided with an inclined mounting surface, and the sensor housing 830 of the image sensor module 800 may be mounted on the mounting surface of the housing 100.

The mounting surface of the housing 100 may be inclined to have an acute angle with respect to the inner bottom surface of the housing 100.

The image sensor 810 may be accommodated in the sensor housing 830 and may be mounted on the printed circuit board 820.

The infrared cut filter 850 may be disposed in front of the image sensor 810, and the infrared cut filter 850 may be coupled to the sensor housing 830.

The reinforcing plate 840 may be mounted on the rear side of the printed circuit board 820 (opposite the surface on which the image sensor 810 is mounted) to reinforce rigidity.

A connector for electrical connection with a portable electronic device may be disposed on the printed circuit board 820.

Since the image sensor 810 is disposed at an angle, the size of the image sensor 810 may be maximized in a narrow space. Accordingly, high-resolution image capture may be possible while reducing the size of the camera module 1.

FIG. 17 is a perspective view of a reflective member of the first reflective module according to another embodiment of the present disclosure.

Referring to FIG. 17, a correction lens 213 may be coupled to the reflection member 310 of the first reflective module 300. The correction lens 213 may have positive refractive power.

In an embodiment, the exit surface of the reflection member 310 of the first reflective module 300 and the object-side surface of the correction lens 213 may be joined.

Accordingly, when the first reflective module 300 is rotated, the correction lens 213 may also be rotated together with the first reflective module 300.

The present disclosure corrects shaking by rotating the first lens module 210 and the first reflective module 300 about the first axis (X-axis) and the second optical axis (Z-axis), the error in the optical path that occurs during shake correction can be reduced.

As illustrated in FIG. 17, when a correction lens with positive refractive power is disposed behind the reflection member 310 of the first reflective module 300, the error in the optical path that occurs during shake correction may be additionally compensated, and high-quality images can be taken.

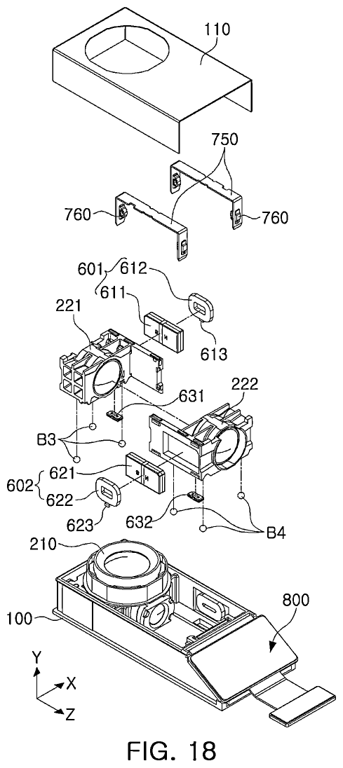

FIG. 18 is a partial exploded perspective view of a camera module according to another embodiment of the present disclosure.

The camera module of the embodiment illustrated in FIG. 18 includes a second lens module 221 and a third lens module 222.

The second lens module 221 and the third lens module 222 each include a plurality of lenses, and the plurality of lenses are arranged along the second optical axis (Z-axis).

The second lens module 221 and the third lens module 222 each have an extension portion extending in the second optical axis (Z-axis) direction.

The second lens module 221 may have one side surface and the other side surface spaced apart in the first axis (X-axis) direction, and the extension portion of the second lens module 221 may extend from one side surface of the second lens module 221 in the direction of the second optical axis (Z-axis).

The third lens module 222 may have one side surface and the other side surface spaced apart in the first axis (X-axis) direction, and the extension portion of the third lens module 222 may extend from the other side surface of the third lens module 222 in the direction of the second optical axis (Z-axis).

For example, the extension part of the second lens module 221 and the extension part of the third lens module 222 may be arranged to overlap in the first axis (X-axis) direction.

In an embodiment, at least a portion of the extension portion of the second lens module 221 and at least a portion of the extension portion of the third lens module 222 may face each other in the first axis (X-axis) direction.

The second lens module 221 may be movable in the second optical axis (Z-axis) direction. In an embodiment, the camera module may include a third driving unit 601.

The third driving unit 601 includes a third magnet 611 and a third coil 612. The third magnet 611 and the third coil 612 may be arranged to face each other in the first axis (X-axis) direction.

The third magnet 611 is mounted on the second lens module 221. As an example, the third magnet 611 may be disposed on one side surface of the second lens module 221. Also, at least a portion of the third magnet 611 may be disposed on an extension portion of the second lens module 221.

The third magnet 611 may be magnetized so that one surface (e.g., the surface facing the third coil 612) has both an N-pole and an S-pole. For example, one surface of the third magnet 611 facing the third coil 621 may be provided with an N-pole, a neutral region, and an S-pole in order in the second optical axis (Z-axis) direction.

The third coil 612 is arranged to face the third magnet 611. The third coil 612 is disposed on the substrate 900, and the substrate 900 is mounted on the housing 100 such that the third magnet 611 and the third coil 612 face each other in the first axis (X-axis) direction.

The housing 100 is provided with a through-hole that penetrates the housing 100, and the third coil 612 disposed on the substrate 900 may face the third magnet 611 directly through the through-hole.

When the power is applied to the third coil 612, the electromagnetic force between the third magnet 611 and the third coil 612 may move the second lens module 221 in the second optical axis (Z-axis) direction.

The third ball member B3 is disposed between the second lens module 221 and the housing 100, and the second lens module 221 may be guided by the third ball member B3 to move in the second optical axis (Z axis) direction. The third ball member B3 may include three balls. For example, three balls may be configured to form a triangle with three ball connections.

Two of the three balls are spaced apart in the second optical axis (Z-axis) direction and may be arranged closer to one side surface than to the other side surface of the second lens module 221.

The remaining one of the three balls may be disposed closer to one side surface than to the other side surface of the second lens module 221.

The third pulling magnet 631 may be disposed on the lower surface of the second lens module 221, and a third pulling yoke may be disposed on the inner bottom surface of the housing 100. In another embodiment, the third pulling magnet 631 may be disposed in both the second lens module 221 and the housing 100.

The third pulling magnet 631 may be disposed closer to one side surface than to the other side surface of the second lens module 221. That is, the third pulling magnet 631 may be disposed closer on one side surface of the second lens module 221 where the third magnet 611 is mounted, than to the other side surface of the second lens module 221 where the third magnet 611 is not mounted.

The third pulling magnet 631 may be disposed between one side surface of the second lens module 221 and the second optical axis (Z-axis).

Two of the three balls of the third ball member B3 may be disposed in the space between the third pulling magnet 631 and one side surface of the second lens module 221.

The third pulling yoke may be disposed in the position facing the third pulling magnet 631 and the first optical axis (Y-axis) direction. The third pulling magnet 631 and the third pulling yoke may generate attractive force between each other.

A plurality of guide grooves may be disposed on the surface where the second lens module 221 and the housing 100 face each other. The three balls of the third ball member B3 are disposed in a plurality of guide grooves.

Some of the plurality of guide grooves may extend to the lower surface of the extension portion of the second lens module 221. In addition, one of the two balls of the third ball member B3 disposed close to one side surface of the second lens module 221 may be located between the extension portion of the second lens module 221 and the housing 100.

Two balls of the third ball members B3, disposed close to one side surface of the second lens module 221, each contact with two-points of the guide groove of the second lens module 221, and two-points contact with the guide groove of the housing 100.

A ball of the third ball members B3 disposed close to the other side surface of the second lens module 221 contacts with two-points of the guide groove of the second lens module 221 and one-point contact with the guide groove of the housing 100 (and vice versa).

In an embodiment, the camera module may detect the position of the second lens module 221. To this end, the third position sensor 613 is provided. The third position sensor 613 may be disposed at a position facing the third magnet 611 (e.g., a position facing the first axis (X-axis)).

Therefore, when the second lens module 221 moves in the second optical axis (Z-axis) direction, the position of the second lens module 221 may be detected through the third position sensor 613. The third position sensor 613 may be a hall sensor.

The third lens module 222 may be movable in the second optical axis (Z-axis) direction. In one embodiment, the camera module may include a fourth driving unit 602.

The third lens module 222 may be able to move in the second optical axis (Z-axis) direction. In an embodiment, the camera module may include a fourth driving unit 602.

The fourth driving unit 602 includes the fourth magnet 621 and the fourth coil 622. The fourth magnet 621 and the fourth coil 622 may be disposed to face each other in the first axis (X-axis) direction.

The fourth magnet 621 is mounted on the third lens module 222. For example, the fourth magnet 621 may be disposed on the other side surface of the third lens module 222. Also, at least a portion of the fourth magnet 621 may be disposed in the extension portion of the third lens module 222.

The fourth magnet 621 may be magnetized such that one surface (e.g., the surface facing the fourth coil 622) has both an N-pole and an S-pole. For example, one surface of the fourth magnet 621 facing the fourth coil 622 may be provided with an N-pole, a neutral region, and an S-pole in sequence in the second optical axis (Z-axis) direction.

The fourth coil 622 is arranged to face the fourth magnet 621. The fourth coil 622 is disposed on the substrate 900, and the substrate 900 is mounted on the housing 100 such that the fourth magnet 621 and the fourth coil 622 face each other in the first axis (X-axis) direction.

The housing 100 may be provided with a through-hole that penetrates the housing 100, and the fourth coil 622 disposed on the substrate 900 may face the fourth magnet 621 directly through the through-hole.

When the power is applied to the fourth coil 622, the electromagnetic force between the fourth magnet 621 and the fourth coil 622 may move the third lens module 222 in the second optical axis (Z-axis) direction.

The fourth ball member B4 is disposed between the third lens module 222 and the housing 100, and the third lens module 222 may be guided by the fourth ball member B4 to move in the second optical axis (Z axis). The fourth ball member B4 includes three balls. The three balls can be configured so that the shape of the three balls connected to each other forms a triangle.

Two of the three balls are spaced apart in the second optical axis (Z-axis) direction and may be disposed closer to the other side surface than to one side surface of the third lens module 222.

The remaining one of the three balls may be disposed closer to one side surface than to the other side surface of the third lens module 222.

The fourth pulling magnet 632 may be disposed on the lower surface of the third lens module 222, and a fourth pulling yoke may be disposed on the inner bottom surface of the housing 100. In another embodiment, it may be able to dispose the fourth pulling magnet 632 in both the third lens module 222 and the housing 100.

The fourth pulling magnet 632 may be disposed closer to the other side surface than one side surface of the third lens module 222. That is, the fourth pulling magnet 632 may be disposed closer to the other side surface of the third lens module 222 where the fourth magnet 621 is mounted, than to one side surface of the third lens module 222 where the fourth magnet 621 is not mounted.

The fourth pulling magnet 632 may be disposed between the other side surface of the third lens module 222 and the second optical axis (Z-axis).

Two of the three balls of the fourth ball member B4 may be disposed in the space between the fourth pulling magnet 632 and the other side surface of the third lens module 222.

The fourth pulling yoke may be disposed in the position facing the fourth pulling magnet 632 in the first optical axis (Y-axis) direction. The fourth pulling magnet 632 and the fourth pulling yoke may generate attractive force between each other.

A plurality of guide grooves may be disposed on the surface where the third lens module 222 and the housing 100 face each other. The three balls of the fourth ball member B4 are disposed in a plurality of guide grooves.

Some of the plurality of guide grooves may extend to the lower surface of the extension portion of the third lens module 222. In addition, one of the two balls of the fourth ball member B4 disposed close to the other side surface of the third lens module 222 is disposed between the extension portion of the third lens module 222 and the housing 100.

Two balls of the fourth ball members B4, disposed close to the other side surface of the third lens module 222, each contact the guide groove of the third lens module 222 at two-points, and two-points contact with the guide groove of the housing 100.

A ball of the fourth ball members B4 disposed close to one side surface of the third lens module 222 makes contact the guide groove of the third lens module 221 at two-points, one-point contact with the guide groove of the housing 100.

In an embodiment, the camera module may detect the position of the third lens module 222. To this end, the fourth position sensor 623 is provided. The fourth position sensor 623 may be disposed at a position facing the fourth magnet 621 (e.g., a position facing the first axis (X-axis)).

Accordingly, when the third lens module 222 moves in the direction of the second optical axis (Z-axis), the position of the third lens module 222 may be detected through the fourth position sensor 623. The fourth position sensor 623 may be a hall sensor.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A reflective module comprising:
a first lens module having a first optical axis;
a holder on which a reflective member is disposed to reflect light passing through the first lens module;
a guide member on which the holder is disposed;
a housing accommodating the holder and the guide member;
a first ball member, disposed between the guide member and the housing, comprising a plurality of balls spaced apart in a direction of a first rotation axis, perpendicular to the first optical axis; and
a second ball member, disposed between the holder and the guide member, comprising a plurality of balls spaced apart in a direction of a second rotation axis perpendicular to both the first optical axis and the first rotation axis,
wherein the guide member is configured to rotate about the first rotation axis, together with the first lens module and the holder,
wherein the first lens module and the holder are configured to rotate together about the second rotation axis, and
wherein the reflective member is disposed between the plurality of balls of the first ball member.

2. The reflective module of claim 1, wherein a first guide groove is disposed on the guide member, a second guide groove is disposed on the housing, and the first guide groove and the second guide groove face each other in the direction of the first optical axis,
wherein the first ball member is disposed between the first guide groove and the second guide groove, and
wherein some balls of the plurality of balls of the first ball member have a different total number of contact points with the first guide groove and the second guide groove than other balls of the plurality of balls of the first ball member.

3. The reflective module of claim 1, wherein a third guide groove is disposed in the holder, a fourth guide groove is disposed in the guide member, and the third guide groove and the fourth guide groove face each other in the direction of the first optical axis,
wherein the second ball member is disposed between the third guide groove and the fourth guide groove, and
wherein some balls of the plurality of balls of the second ball member have a different total number of contact points with the third guide groove and the fourth guide groove than other balls of the plurality of balls of the second ball member.

4. The reflective module of claim 1, further comprising a first driving unit comprising a first magnet disposed on the guide member and a first coil disposed to face the first magnet in the direction of the first optical axis,
wherein one surface of the first magnet facing the first coil has an N-pole, a neutral region, and an S-pole in the direction of the second rotation axis.

5. The reflective module of claim 4, wherein a virtual line connecting the plurality of balls of the first ball member is offset from the first magnet in the direction of the first optical axis.

6. The reflective module of claim 4, wherein a first pulling yoke spaced apart from the first magnet in the direction of the first optical axis is disposed in the housing.

7. The reflective module of claim 1, wherein a first pulling magnet is disposed on one of the holder or the guide member, and a second pulling yoke is disposed on another thereof,
wherein the first pulling magnet and the second pulling yoke face each other in the direction of the first optical axis, and
wherein one surface of the first pulling magnet facing the second pulling yoke has an N-pole, a neutral region, and an S-pole in the direction of the second rotation axis.

8. The reflective module of claim 7, wherein a length of the pulling yoke in the direction of the first rotation axis is longer than a length of the first pulling magnet in the direction of the first rotation axis.

9. The reflective module of claim 7, wherein the first pulling magnet and the second pulling yoke are disposed between the plurality of balls of the second ball member.

10. The reflective module of claim 1, further comprising a second driving unit comprising a second magnet disposed in the holder and a second coil disposed to face the second magnet in the direction of the first rotation axis,
wherein one surface of the second magnet facing the second coil has an N-pole, a neutral region, and an-S pole along the first optical axis.

11. The reflective module of claim 10, wherein a virtual line connecting the plurality of balls of the second ball member is offset from the second magnet in the direction of the first rotation axis.

12. The reflective module of claim 1, wherein a first stopper, coupled to the housing, covers at least a portion of the upper surface of the holder, and
wherein a buffer member is disposed on at least one surface of the first stopper and the holder facing the direction of the first optical axis.

13. The reflective module of claim 1, wherein a second stopper is coupled to the guide member,
wherein the holder has a receiving portion in which a portion of the second stopper is disposed, and
wherein the portion of the second stopper has a surface facing the receiving portion in the direction of the first optical axis.

14. A camera module comprising the reflective module of claim 1.

15. A camera module comprising:
a guide member disposed in a housing to rotate about a first rotation axis;
a holder disposed on the guide member to rotate relative to the guide member based on a second rotation axis perpendicular to the first rotation axis, and on which a reflective member is disposed;
a first ball member disposed between the guide member and the housing;
a second ball member disposed between the holder and the guide member;
a first lens module disposed on the holder and having a first optical axis perpendicular to both the first and second rotation axes; and
a second lens module into which light reflected from the reflective member is incident, and having a second optical axis,
wherein the first rotation axis is perpendicular to both the first optical axis and the second optical axis.

16. The camera module of claim 15, further comprising an image sensor configured to receive light passing through the second lens module, the image sensor having an imaging plane that is inclined with respect to the second optical axis.

17. The camera module of claim 15, further comprising:
a first driving unit comprising a first magnet disposed on the guide member, and a first coil disposed to face the first magnet in a direction of the first optical axis; and
a second driving unit comprising a second magnet disposed in the holder and a second coil disposed to face the second magnet in a direction of the first rotation axis,
wherein the first ball member comprises a plurality of balls spaced apart in the direction of the first rotation axis, and
wherein the second ball member comprises a plurality of balls spaced apart in a direction of the second rotation axis.

18. The camera module of claim 17, wherein a first pulling yoke spaced apart from the first magnet in the direction of the first optical axis is disposed in the housing,
wherein a first pulling magnet is disposed on one of the holder or the guide member, and a second pulling yoke facing the first pulling magnet in the direction of the first optical axis is disposed on another thereof, and
wherein the first pulling magnet and the second pulling yoke are disposed between the plurality of balls of the second ball member.
